(19) United States
(12) Patent Application Publication
(10) Pub. No.: US 2005/0158654 A1
(43) Pub. Date: Jul. 21, 2005

(54) Reducing outgassing of reactive material upon exposure of photolithography resists

(76) Inventors: Wang Yueh, Portland, OR (US); Ernisse S. Putna, Beaverton, OR (US)

Correspondence Address: TROP PRUNER & HU, PC, 8554 KATY FREEWAY, SUITE 100, HOUSTON, TX, 77024, US

(21) Appl. No.: 10/761,842

(22) Filed: Jan. 21, 2004

(51) Int. Cl. G03C 1/492

(52) U.S. Cl. 430/270.1

(57) ABSTRACT

Outgassing of reactive material upon exposure of a photolithographic resist may be reduced. Outgassing may foul optical components of the photolithographic system. In one embodiment, a ring compound with iodine or sulfur may be formed. The ring compound may be more resistant to the generation of reactive outgassing components.

### BACKGROUND

This invention relates generally to the manufacture of semiconductor integrated circuits and, particularly, to photolithography processes for manufacturing such circuits.

In the manufacture of semiconductor integrated circuits, a photoresist film is formed over a semiconductor wafer. The photoresist film may be irradiated so that some regions of the photoresist film are either harder or easier to remove. As a result, a pattern can be repeatedly transferred to the semiconductor wafer via the photoresist film. After developing, the photoresist film may be used as a mask for etching desired features in the underlying layers of the semiconductor wafer.

Advances in photolithography techniques utilized to transfer patterns to photoresist have enabled increasingly smaller patterns to be transferred. This means that smaller integrated circuit features can be formed in integrated circuits. As a result, more elements can be put in a given area on a semiconductor integrated circuit. One result of these advances has been to reduce the cost of integrated circuits.

One advanced photolithography technology is extreme ultraviolet technology (EUV). It uses chemically amplified photoresists that employ photoacid generators (PAGs). These photoacid generators generate acids upon exposure to appropriate irradiation. The acids will cleave the protecting groups on the photoresists and switch the photoresist's solubility in the base aqueous developer.

Photoacid generators developed for prior photo-lithography technologies may achieve relatively good quantum yields at the required wavelengths. However, these photoacid generators will outgas under extreme ultraviolet irradiation under vacuum. Outgassing is the release of gases or vapors by a material over time. Outgassing may result in degradation of the lens used in the extreme ultraviolet optics due to photoresist fragment deposition related to outgassing.

Currently, photoacid generator technology to date has focused primarily on perfluorooctane sulfonate (PFOS) and perfluoroalkyl sulfonate (PFAS) anion and phenyl-based cation photoacid generators. However, the cation portion of the photoacid generators of this type will outgas after extreme ultraviolet irradiation under vacuum. The semiconductor industry has committed to developing and using PFOS-free photoacid generators in extreme ultraviolet production.

### BRIEF DESCRIPTION OF THE DRAWINGS

FIG. 1 is a photoacid generator in accordance with one embodiment of the present invention; and

FIG. 2 is a photoacid generator in accordance with another embodiment of the present invention.

### DETAILED DESCRIPTION

A photoacid generator may include a cation or photon harvesting part and an anion or photon generating part. By altering the cation portion of the photoacid generator, outgassing may be reduced. In one embodiment, outgassing may be reduced by better stabilization of the cation under irradiation. A ring, sigma-bonded group, such as a sulfonium or iodonium group, in conjunction with a traditional phenyl group configuration, may replace the traditional linear or branched sigma-bonded sulfonium or iodonium groups in the cation portions of a photoacid generator. While phenyl groups remain to ensure sufficient quantum efficiency and thermal stability, the sulfonium or iodonium groups may be maintained in a more highly stabilized, conjugated configuration. Since this ring configuration is more stable, less outgassing may occur.

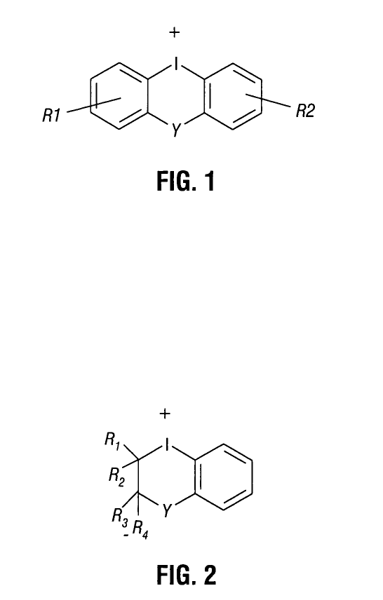

Referring to FIG. 1, in accordance with one embodiment, a pair of aromatic rings may be joined by a ring including the iodine element “I” and a moiety Y. Instead of the iodine atom, the ring may include a sulfur atom. The iodine or sulfur containing ring may be sigma-bonded. The aromatic rings may be phenyl groups. The moiety Y may be oxygen, sulfur, CH₂ or iodine in some embodiments of the present invention. The two conjugated or aromatic rings may include the elements R1 and R2. For example, R1 and R2 may be alkyls, phenyls, or caged alkyls, attached to the indicated rings. The cation may be paired with conventional anions including ClO₄, SbF₆, and PFAS.

The multi-aromatic ring structure shown in FIG. 2 may include an aromatic ring, such as a phenyl group, coupled to a sigma-bonded ring structure including an iodine atom and the moiety Y already described. Instead of iodine, sulfur may also be used. The constituents R1, R2, R3, and R4 may be any of alkyls, phenyls, or caged alkyls, as examples.

Ring structures of this type provide for extended electronic conjugation when bonded appropriately to phenyl groups in the cation portion of a photoacid generator. Extended conjugation may increase the effective bond disassociation energy of the photoacid generator structure, thereby reducing outgassing. During exposure, the photoacid generator may fragment into smaller molecular weight components. These small components under a vacuum condition will contaminate the extreme ultraviolet optics. Cation type conjugation ring structures also produce better stability and quantum efficiency. The cation will be conjugated throughout the structure. The special conjugation provides a non-fragmenting mechanism during exposure.

The conjugated ring structure may be further stabilized by the addition of various pendant groups, either directly on the ring itself or potentially on the adjacent phenyl groups as well. In addition, the number of phenyl groups utilized and the configuration of the phenyl groups is subject to variability.

Finally, the pendant groups (R1-R4) may be chosen to impart additional strain to the photoacid generator upon photo-activation. This strain may increase photo speed by imparting an overall entropy increase to the system. Thus, tuning of the photoacid generator properties may be possible. Among the properties that may be tuned are acid strength, diffusion length, and reactivity. Photoacid generator reactivity can be tuned by variation of the anion associated with the cation portion of the photoacid generator.

While the present invention may be applicable to a variety of photolithography processes, it may be particularly applicable to extreme ultraviolet photoresist photoacid generators. It may also be integrated into 193 nanometer and 248 nanometer photoresists as well.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A method comprising:
forming a photoresist using photoacid generator having a first ring including iodine or sulfur and an omatic ring an anion selected from the group of ClO₄, SbF₆, and perfluoroalkyl sulfonate.

2. The method of claim 1 including forming said first ring as a sigma-bonded ring.

3. The method of claim 1 including forming an aromatic ring as a phenyl group.

4. The method of claim 1 including forming a napthyl ring structure.

5. The method of claim 1 including bonding said first ring directly to said aromatic ring to form a napthyl ring.

6-10. (canceled)

11. A photoresist comprising:
a photoacid generator including a first ring and an aromatic ring directly bonded to said first ring;
said first ring including two atoms selected from the group including iodine and sulfur; and
an anion selected from the group of ClO₄ SbF₆, and perfluoroalkyl sulfonate.

12. The photoresist of claim 11 wherein said first ring is sigma-bonded.

13. The photoresist of claim 11 including two aromatic rings bonded to said first ring.

14. The photoresist of claim 13 wherein said aromatic rings are bonded on opposite sides of said first ring.

15. The photoresist of claim 6 wherein said aromatic ring is a phenyl group.

16. The photoresist of claim 11 wherein said aromatic ring has an alkyl, phenyl, or caged alkyl attached to said ring.

17. (canceled)
